(19) United States
(12) Patent Application Publication
(10) Pub. No.: US 2007/0051462 A1
(43) Pub. Date: Mar. 8, 2007

(54) Substrate assembly apparatus and method

(76) Inventors: Yukinori Nakayama, Toride (JP); Tatsuharu Yamamoto, Ryugasaki (JP); Masayuki Saito, Tsukubamirai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/513,071

(22) Filed: Aug. 31, 2006

(30) Foreign Application Priority Data
Sep. 2, 2005 (JP) 2005-254302

(51) Int. Cl. B29C 65/00

(52) U.S. Cl. 156/285; 156/382

(57) ABSTRACT

A substrate bonding apparatus for bonding substrates together in a vacuum at high speeds, with a high degree of accuracy includes a first chamber C1, a second chamber C2, and a third chamber C3. Two substrates to be bonded together are loaded in the first chamber C1. The two substrates are bonded together in the second chamber C2. The two substrates bonded together are unloaded in the third chamber C3. The first and third chambers are variably controlled from an atmospheric pressure state to a medium vacuum state. The second chamber is variably controlled from the medium vacuum state to a high vacuum state.

### BACKGROUND OF THE INVENTION

The present invention relates generally to a substrate bonding apparatus. More specifically, the invention relates to a substrate bonding apparatus and a substrate bonding method that are suitable for assembling a liquid crystal display panel by opposingly holding substrates to be bonded together within a vacuum chamber, reducing a gap therebetween and bonding the substrates together.

For encapsulation of liquid crystal, a known method follows steps as detailed below. Specifically, liquid crystal is dropped onto a first substrate on which a sealant-closed pattern is formed so as not to provide an injection port. A second substrate is then disposed above the first substrate within a vacuum chamber. The first and second substrates are then brought close to each other and bonded together. Japanese Patent Laid-open No. 2001-305563 discloses an apparatus that includes a preliminary chamber for loading substrates in, and unloading substrates from, the vacuum chamber. The same environment as that in the preliminary chamber is maintained in the vacuum chamber for loading and unloading the substrates.

In the above-referenced related art, in a process of making the environment in the vacuum chamber the same as that in the preliminary chamber for loading and unloading the substrates, it takes a long time to change an atmospheric state to a vacuum state. This time-consuming process becomes a bottleneck in increasing productivity in manufacturing substrates. In addition, in Japanese Patent Laid-open No. 2001-305563, the substrates are placed on rolls for transportation. This poses problems regarding the possibility of damaging the substrates and generation of dust and dirt because of the substrates being transported on the rolls.

### OBJECT AND SUMMARY OF THE INVENTION

Therefore, an object of the invention is to supply a substrate bonding apparatus that can bond substrates quickly. An object of the invention is also to supply a substrate bonding apparatus that can bond substrates highly accurately. Moreover, an object of the invention is also to supply a substrate bonding apparatus that can bond substrates with high productivity. Also, a method(s) corresponding to the above-discussed apparatus is(are) an object of the invention.

To achieve the foregoing objects, according to an aspect of the present invention, a substrate assembly apparatus includes a first chamber, a second chamber, and a third chamber. Two substrates to be bonded together are loaded in the first chamber. The two substrates are bonded together in the second chamber. The two substrates bonded together are unloaded in the third chamber. The first and third chambers are variably controlled from an atmospheric pressure state to a vacuum state that is midway between atmospheric pressure and a high vacuum state in which bonding is carried out (hereinafter referred to as “medium vacuum state”) . The second chamber is variably controlled from the medium vacuum state to the high vacuum state.

According to the aspect of the present invention, an evacuation time, through which the atmospheric pressure state is changed to the high vacuum state and which takes the longest during bonding, can be reduced, particularly when a plurality of liquid crystal display panels are assembled in succession by the substrate assembly apparatus. Bonding of the substrates in a vacuum can also be carried out with a high degree of accuracy.

### BRIEF DESCRIPTION OF THE DRAWINGS

Other objects and advantages of the invention will become apparent from the following description of embodiments with reference to the accompanying drawings in which:

FIG. 1 is a cross-sectional view of a substrate bonding apparatus according to a first embodiment of the present invention;

FIG. 2 is a flowchart illustrating operations of the substrate bonding apparatus shown in FIG. 1;

FIG. 3 is a flowchart, continued from the flowchart of FIG. 2, illustrating operations of the substrate bonding apparatus shown in FIG. 1;

FIG. 4 is a flowchart, continued from the flowchart of FIG. 3, illustrating operations of the substrate bonding apparatus shown in FIG. 1;

FIG. 5 is a cross-sectional view of a substrate bonding apparatus according to a second embodiment of the present invention, in which a dolly is used as a substrate transport mechanism;

FIG. 6A is a partial cross-sectional view of a first and a second chamber;

FIG. 6B is an enlarged view of the dolly as the substrate transport mechanism;

FIG. 7A is a plan view of a substrate bonding apparatus according to a third embodiment of the present invention, in which a rack-and-pinion-based drive system is used as a substrate transport mechanism; and

FIG. 7B is a cross-sectional view of the substrate bonding apparatus of FIG. 7A.

### DESCRIPTION OF THE EMBODIMENTS

Preferred embodiments of the present invention will be described below with reference to the accompanying drawings.

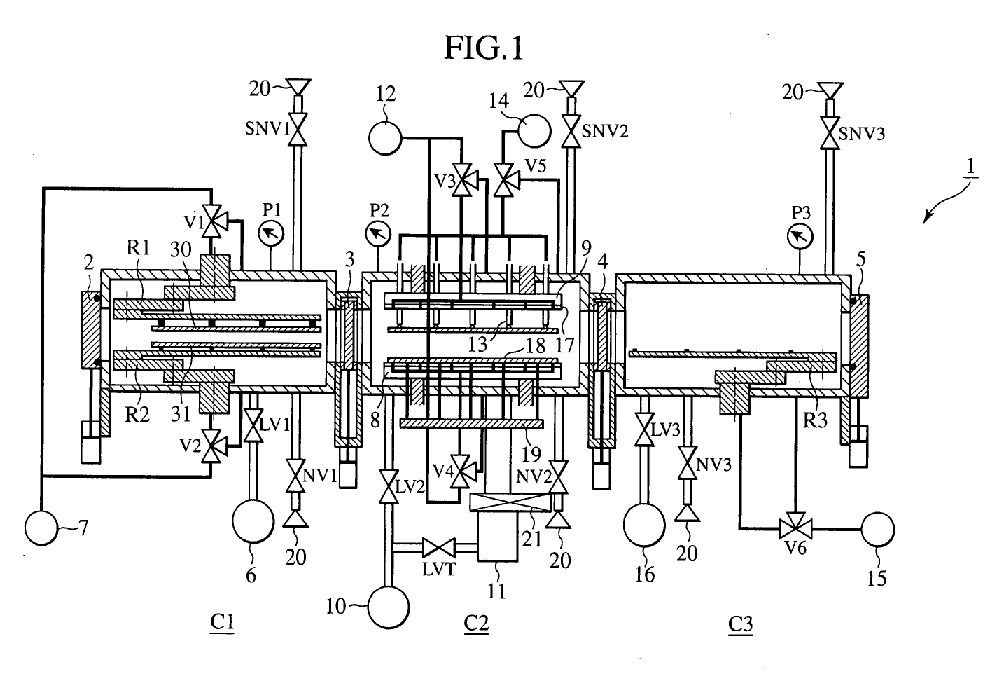

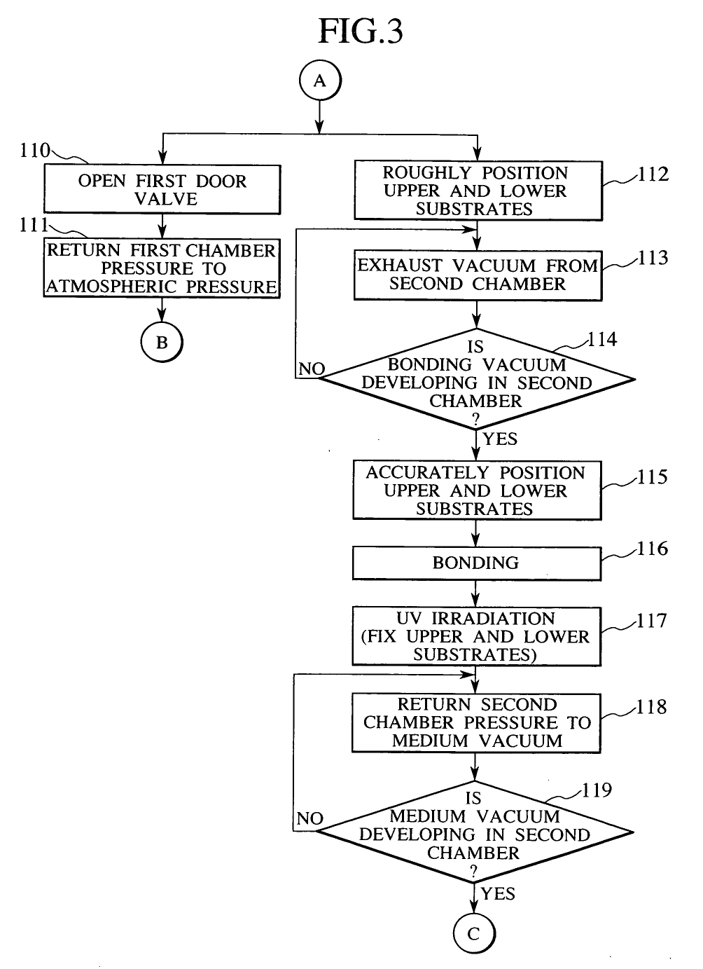

A substrate assembly apparatus or a substrate bonding apparatus according to a first embodiment of the present invention will be described below with reference to FIGS. 1 to 4. Referring to FIG. 1, the substrate bonding apparatus 1 includes a first chamber C1, a second chamber C2, and a third chamber C3. The first chamber C1 is a pre-process chamber (substrate loading chamber), into which substrates are loaded. The second chamber C2 is a vacuum bonding chamber. The third chamber C3 is a post-process chamber, into which bonded substrates (liquid crystal panels) are unloaded. The first chamber C1 includes an upper substrate loading robot hand R1 and a lower substrate loading robot hand R2. These two robot hands R1, R2 are used for loading two substrates (an upper substrate 30 and a lower substrate 31). The third chamber C3 includes an unloading robot hand R3 for unloading bonded substrates. The substrate bonding apparatus 1 also has a first door valve 2, a first gate valve 3, a second gate valve 4, and a second door valve 5. The first door valve 2 is disposed on an entrance side of the first chamber C1. The first gate valve 3 is disposed between the first chamber C1 and the second chamber C2. Similarly, the second gate valve 4 is disposed between the second chamber C2 and the third chamber C3. The second door valve 5 is disposed on an exit side of the third chamber C3.

The substrate bonding apparatus 1 further includes a vacuum pump 6, another vacuum pump 7, and a nitrogen supply source 20. The vacuum pump 6 for depressurizing the first chamber C1 is connected to the first chamber C1 via a supply valve LV1. The vacuum pump 7 is connected to the robot hands R1, R2 via three-way valves V1, V2 to supply a vacuum thereto for picking up substrates through suction. The nitrogen supply source 20 is connected to the first chamber C1 via supply valves NV1, SNVL to supply the first chamber C1 with nitrogen.

The second chamber C2 includes a lower table 8 and an upper table (pressure plate) 9 disposed therein. The lower substrate 31 is placed on the lower table 8. The upper table 9 picks up and holds the upper substrate 30. A vacuum pump 10 and a turbo-molecular pump 11 are provided externally of the second chamber C2. The vacuum pump 10 vacuumizes the second chamber C2. The turbo-molecular pump 11 is connected to the vacuum pump 10 via a supply valve LVT. A third gate valve 21 is disposed on an intake side of the turbo-molecular pump 11. The second chamber C2 is also connected with a vacuum pump 12 for table pickup via three-way valves V3, V4. The vacuum pump 12 supplies a vacuum to the upper and lower tables so that the upper and lower tables can pick up and hold the upper and lower substrates, respectively. The second chamber C2 further includes a suction pad 13 for picking up and holding the upper substrate 30 through suction onto a surface of the upper table 9. The second chamber C2 is also connected via a three-way valve VS with a pad vacuum pump 14 that supplies the suction pad 13 with a vacuum. There are provided a plurality of suction pads 13, each being capable of vertical movement as driven by corresponding drive means not shown. The second chamber C2 is also connected to a nitrogen supply source 20 via supply valves NV2, SNV2. The nitrogen supply source 20 supplies the second chamber C2 with nitrogen. The upper table 9 also includes a holding chuck 17 disposed on a lower surface thereof, in addition to the aforementioned suction pickup ports. The holding chuck 17 lets static electricity or adhesion act on the substrate so that the substrate can be picked up and held in position even in a high vacuum state. The lower table 8 also includes a holding chuck 18. If the holding chuck 18 used for the lower table 8 is a type that lets adhesion act, an arrangement may be made to let the adhesion act locally. In addition, the lower table 8 includes a substrate lifter 19. The substrate lifter 19 has a plurality of receiver claws that make the substrate leave the table surface so that the robot hand R2 can be inserted into a space between the table surface and the substrate. The substrate lifter 19 can thereby receive the lower substrate 31 from the robot hand R2 and pass the bonded substrates to a robot hand R3.

The third chamber C3 is connected with a pickup vacuum pump 15 via a three-way valve V6 and with a vacuum pump 16 via a supply valve LV3. The vacuum pump 15 supplies a vacuum for keeping the bonded substrates mounted on the robot hand in position through suction to prevent the bonded substrates from being moved during unloading. The vacuum pump 16 vacuumizes the third chamber C3. Further, the third chamber C3 is connected with the nitrogen supply source 20 via supply valves NV3, SNV3. The supply valves SNV1 to SNV3 supply a very small amount of nitrogen for maintaining a medium vacuum state or a high vacuum state. The supply valves NV1 to NV3 supply a large amount of nitrogen.

The first, second, and third chambers C1, C2, C3 are provided with pressure gauges P1, P2, P3, respectively. Based on readings on these pressure gauges P1 to P3, operations of the vacuum pumps 6, 7, 10, 12, 15, 16, nitrogen supply valves NV1 to NV3, SNV1 to SNV3, gate valves 3, 4, 21, door valves 2, 5, three-way valves V1 to V5, supply valves LV1 to LV3, and the like are controlled for controlling the vacuum state in each of the three chambers C1, C2, C3.

In accordance with the embodiment, the pressure in the second chamber C2, in which the substrates are bonded together, is controlled so as to maintain a predetermined degree of vacuum (about 150 Torr=20.0 kPa: hereinafter “medium vacuum”) during loading and unloading of substrates. The pressure in the second chamber C2 is then returned to a high vacuum about (5×10⁻³ Torr=0.67 Pa) after the substrates have been loaded. The Medium vacuum state is a pressure state, at which a vacuum ability of pump starts declining, typically about 100˜1,000 [Pa]=0.75˜7.5[Torr]. On the other hand, the high vacuum state is a pressure state in which the substrates bond together, and preferably is about 1[Pa]=7.5×10⁻³ [Torr].

In order to achieve a high vacuum state, the time Tm to go from an atmospheric state to the medium vacuum state is, for example, about 25 seconds, and following this, another 25 seconds is required to reach a high vacuum state. Thus, the total time Th to go from the atmospheric state to the high vacuum state is, for example, about 50 seconds. So the time Tm is about half for the time Th. Incidentally, if a low-molecule liquid crystal is used which has a higher steam pressure than the liquid crystal which was mentioned above, it is possible to make the degree of vacuum state become as high as 5[Pa]=37.5×10⁻³ [Torr].

Accordingly, the second chamber C2 is returned to the predetermined degree of vacuum when each of the first gate valve 3 and the second gate valve 4 is opened. In addition, nitrogen is supplied when the high vacuum is returned to the medium vacuum in the second chamber C2, so that the second chamber C2 is not affected by moisture in the atmosphere.

The degree of vacuum in each of the three chambers is controlled as described above. It is therefore possible to hold the substrates onto the robot hands through suction pickup when not only the substrates are loaded in the first chamber C1, but also when the substrates are conveyed from the first chamber C1 to the second chamber C2 with the predetermined degree of vacuum maintained.

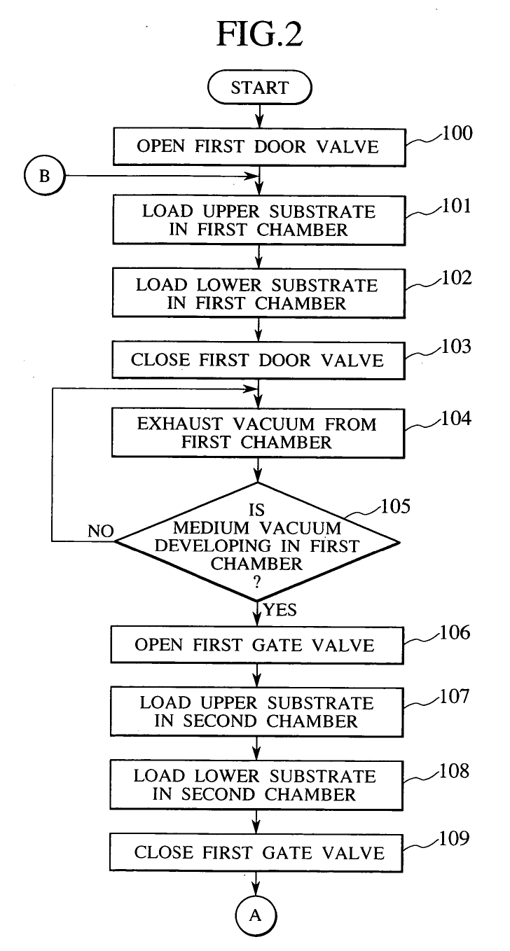

Operation of the substrate bonding apparatus will be described with reference to FIGS. 2, 3, and 4.

FIGS. 2 through 4 are a flowchart showing operations of the substrate bonding apparatus according to the embodiment of the present invention.

The first door valve 2 at the entrance of the first chamber C1 is opened to pass the upper substrate 30 and the lower substrate 31 to be bonded together onto the robot hands R1, R2, respectively, in the first chamber C1 (step 100). The vacuum pump 7 is then driven and the three-way valves V1, V2 are operated to send a vacuum to a substrate holding portion of each of the robot hands R1, R2. The upper substrate loading robot hand R1 in the first chamber C1 then picks up the upper substrate 30 through suction and loads the upper substrate 30 in the first chamber C1 (step 101). Similarly, the lower substrate loading robot hand R2 in the first chamber C1 picks up the lower substrate 31 through suction and loads the lower substrate 31 in the first chamber C1 (step 102). When loading of the upper and lower substrates in the first chamber C1 is completed, the first door valve 2 is closed (step 103). When the first door valve 2 is closed, the vacuum pump 6 is operated so that the first chamber C1 is exhausted until the medium vacuum develops therein (steps 104, 105).

Since the upper and lower substrates are held in position through suction in the first chamber C1, gas in the first chamber C1 is drawn out at all times through micro-leakage. Accordingly, the same amount of nitrogen as that of the gas that has leaked is supplied via SNV1 to maintain a predetermined medium vacuum state. If the substrates are held in position through suction in the first through third chambers kept in the medium vacuum state, each chamber is not free from micro-leakage. Control is therefore provided to supply nitrogen at all times to keep constant the internal pressure of each chamber.

While the first chamber C1 is kept in the medium vacuum state, the medium vacuum state develops in the second chamber C2. Alternatively, previously loaded substrates may be being bonded together in a high vacuum state, or the substrates previously loaded in and bonded together may be being unloaded (in which case, the medium vacuum state develops both in the second chamber C2 and the third chamber C3). The embodiment of the present invention has bee described on the assumption that the second chamber C2 is set in a standby state with no substrates existing therein.

When the medium vacuum state develops in the first chamber C1, the first gate valve 3 is opened (step 106). With the first gate valve 3 opened, the robot hands R1, R2 that hold the upper and lower substrates 30, 31, respectively, are operated so that the upper and lower substrates 30, 31 are passed onto the upper and lower tables 9, 8, respectively, in the second chamber C2. The plurality of suction pads 13 are placed on the upper table 9. The vacuum pump 14 is then run and the three-way valve V5 is opened to a side of supplying the suction pads 13 with a vacuum, so that vacuum is supplied to the pickup ports. When the substrate is passed onto the suction pads 13 from the upper substrate loading robot hand R1, the suction pads 13 are advanced and protruded from the surface of the upper table 9 so that the suction ports are brought near to, and pick up, a substrate surface. The robot hand R1 opens the three-way valve V1 to a side that provides communication with the chamber, releases the suction pickup force, passes the substrate onto the suction pads 13, and moves back. The suction pads 13 thereafter go up until the pads 13 are located at the table surface. When the suction pads 13 are located flush with the table surface, the three-way valve V3 is opened to a side that supplies the vacuum from the vacuum pump 12 to the table surface. The upper substrate 30 is then attracted, and picked up and held in position through suction on the surface of the upper table 9. The holding chuck 17 is thereafter operated in the vacuum state and the upper substrate 30 is held in position. Similarly, the lower substrate loading robot hand R2 is operated to load the lower substrate 31 on the robot hand R2 onto the surface of the lower table 8. The substrate lifter 19 is raised to receive the lower substrate 31 from the robot hand R2 onto the lower table 8. Thereafter, the upper and lower substrate loading robot hands R1, R2 are returned to the first chamber C1. The substrate lifter 19 is then lowered so that the lower substrate 31 is placed on the surface of the lower table 8. In addition, the first gate valve 3 is closed (step 109). At this time, the vacuum pump 12 is run and the three-way valve V4 is opened to a side that provides vacuum to the lower table 8. A vacuum is thereby supplied to the plurality of suction pickup ports in the surface of the lower table 8 and the lower substrate 31 is picked up and held in position through suction on the surface of the lower table 8. The in-vacuum holding chuck 18 including an electrostatic pickup mechanism or an adhesion pickup mechanism is operated so that the lower substrate 31 is secured in position on the surface of the lower table 8. Understandably, loading of the upper and lower substrates in the second chamber C2 may be performed at the same time.

When the steps as described above are completed, the first door valve 2 of the first chamber C1 is opened (step 110) to return the medium vacuum back to the atmospheric pressure in the first chamber C1 (step 111). The first chamber C1 is thereby made to be ready for loading of the next substrates. Rough positioning of the upper and lower substrates is performed in the second chamber C2 (step 112). The rough positioning of the upper and lower substrates is performed as below. Specifically, although not shown, a plurality of positioning marks made in advance on each of the upper and lower substrates are observed using a plurality of cameras. The amount of deviation in position between the two substrates is thereby obtained and the lower table 8 is moved horizontally to eliminate the deviation. It is to be noted that a drive mechanism for moving the lower table 8 horizontally, including a friction sliding portion, is mounted externally on the second chamber C2. A coupling shaft included in the lower table 8 is connected to the drive mechanism via an elastic body formed, for example, from a bellows or the like. The vacuum state can thereby be maintained in the second chamber C2.

The second chamber C2 kept in the medium vacuum state is next set to an even higher vacuum state by operating the vacuum pump 10 and the turbo-molecular pump 11 (step 113). It is then determined whether the degree of vacuum appropriate for bonding of substrates develops in the second chamber C2 (step 114). If it is determined that the degree of vacuum appropriate for bonding is reached, the upper and lower substrates are accurately positioned (step 115). Thereafter, the upper table 9 is controlled to move toward the lower table 8 and, while the pressure and the gap between the upper and lower substrates 30, 31 are being measured, bonding is executed through pressurization (step 116). Control is exercised to position the two substrates accurately a number of times in the middle of the bonding sequence (in the middle of pressurization). Pressurization is completed as soon as a predetermined pressurizing force and a predetermined gap between substrates are reached.

In the preferred embodiment of the present invention, the upper table 9 is moved vertically to effect bonding. It is nonetheless appropriate that the lower table 8 be raised to effect bonding with the upper table 9 fixed in position.

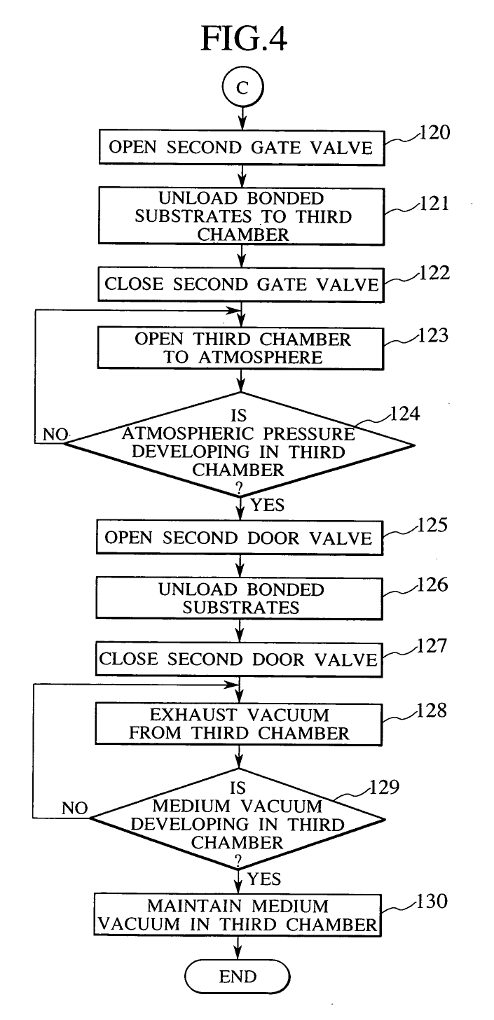

When pressure bonding is completed, adhesives for temporary fixing are irradiated with UV light, so that the substrates are temporarily secured together (step 117). Temporary fixing may be performed in the third chamber C3 after the third chamber C3 is open to the atmosphere (step 124). The upper table 9 is then raised. Next, a nitrogen gas is supplied into the second chamber C2 and the second chamber C2 is pressurized until the medium vacuum state is reached (step 118). It is determined whether the medium vacuum state develops in the second chamber C2 (step 119). If it is determined that the medium vacuum state develops in the second chamber C2, the second gate valve 4 is opened (step 120 of FIG. 4).

The substrate lifter 19 in the second chamber C2 is then operated to lift the bonded substrates from the surface of the lower table 8. The robot hand R3 in the third chamber C3 is then operated and extended up to a point of transfer of the bonded substrates. When the robot hand R3 receives the bonded substrates, the vacuum pump 15 is activated to secure the bonded substrates onto the robot hand R3. The robot hand R3 is then contracted so that the bonded substrates are loaded into the third chamber C3 (step 121). When the bonded substrates are loaded in the third chamber C3, the second gate valve 4 is closed and the nitrogen gas is supplied to pressurize the third chamber C3 to the atmospheric pressure (step 123). If the substrates are not temporarily fixed in vacuum, temporary fixing through UV light is performed in this step. The second door valve 5 is thereafter operated to open and the bonded substrates are unloaded from the third chamber C3 and fed onto the next process (step 126). When the bonded substrates are unloaded from the third chamber C3, the second door valve 5 is closed (step 127). The vacuum pump 16 is next operated to evacuate the third chamber C3, bringing it into the medium vacuum state (step 128). It is determined whether the medium vacuum state develops in the third chamber C3 (step 129). If it is determined that the medium vacuum state develops in the third chamber C3, the medium vacuum state is maintained (step 130).

The substrate bonding apparatus according to the embodiment operates as described in the foregoing. The time required for bonding the substrates can be substantially shortened by performing substantially simultaneously the operation of the first gate valve 3 and the second gate valve 4, loading of the substrates in the second chamber C2, and unloading of the bonded substrates.

A conventional way to make a liquid crystal panel from a pair of substrates typically uses an apparatus which is similar to FIG. 1, but which does not have any gate valves between the chambers. In other words, the structure is effectively one large chamber made up of three sub-chambers without any gate valves between the sub-chambers. Using such a structure the conventional method typically uses the following steps:

1. Loading and unloading substrates to and from the sub-chambers;

2. Vacuuming the chamber (e.g. all of the sub-chambers) from atmospheric pressure to high vacuum state; and

3. Positioning the substrates and bonding the substrates. Each step takes about the same amount of time. If the amount of time for each of these steps is T0, a time to make the bonded substrates should be calculated as follows. So, if one wants to make n pieces of bonded substrates, the required time is 3n T0 as explained below.

First, loading the substrates to C1 requires 0.5 T0. Moving the substrates to C2 and vacuuming C2 to the high vacuum state requires T0, and positioning and bonding the substrates requires T0. Then, returning to the atmospheric pressure state and unloading the bonded substrates requires 0.5 T0. Thus, a total time is about 3 T0. To make a second panel of bonded substrates takes 3 T0 because it requires the same procedure. Therefore, if one wants to make two pieces or panels of bonded substrates, it takes 6 T0. If one wants to make n pieces or panels of bonded substrates, using conventional techniques, it takes 3n T0. On the other hand, the required time to make bonded substrates according to the present invention is discussed below.

The first substrates to be bonded takes an amount of time 0.5 T0 to load to C1, 0.5 T0 to vacuum C1 from an atmospheric pressure state to a medium vacuum state, 0.5 T0 to load to C2 and to vacuum C2 from the medium vacuum state to a high vacuum state, T0 to position the substrates and to bond them, almost 0 T0 to open the gate valve to return C2 to a medium vacuum state, and 0.5 T0 to unload the bonded substrates and to return C3 to atmospheric pressure state. Therefore, it takes about 3 To from loading substrates to be bonded to unloading the bonded substrates. However, the advantage of the present invention comes about when a plurality of panels or sets of substrates are made in succession, as discussed below.

As noted above, the time to vacuum a chamber from the atmospheric pressure state to the medium vacuum state and the time to vacuum a chamber from the medium vacuum state to the high vacuum state are about the same amount of time. Specifically, about half the time required to go from atmospheric pressure state to an amount of high vacuum state.

If a second set of substrates to be bonded is loaded to C1 after T0 from the first set of first substrates to be bonded are loaded to C2, the unloading timing of first substrate from C2 is after positioning and bonding the substrates, and 1.5 T0 is passed inside C2. Unloading the first set of bonded substrates from C2 is carried out in the medium vacuum state. By the time positioning and bonding of the first set of substrates in C2 finishes, vacuuming process of the second set of substrates in C1 to reach the medium vacuum state from the atmospheric pressure state be completed.

Next, the second set of substrates to be bonded will be loaded from C1 to C2 in the medium vacuum state. Therefore, unloading a k^{th} set of substrates from C2 and loading a (k+1)^{th} set of substrates to C2 proceed at one time. When positioning and bonding substrates of the second set of substrates in C2 is finished, the first set of bonded substrates is already unloaded from C3. Therefore, the second set of bonded substrates is unloaded from C2 to C3 and C3 is returned to the atmospheric pressure state after the procedure in C2. Of course, C2 keeps the medium vacuum state.

Therefore, returning C3 to the atmospheric pressure state of k^{th} set of substrates and loading substrates to C2 of the (k+1)^{th} set of substrates and vacuuming C2 to the high vacuum state of the (k+1)^{th} set of substrates proceed at one time. Thus, the timing to finish making the (k+1)^{th} set of substrates is the timing after positioning and bonding substrates in C2 and returning C3 to the atmospheric pressure state from the timing of finishing making the k^{th} set of substrates. So, the timing to finish making the(k+1)^{th} set of substrates is thought to be increased 1.5 T0 from the timing to finish making the k^{th} set of substrates. So, the time to make n pieces or sets of substrates requires 3·T0+1.5·(n−1)·T0.

Comparing the time of the conventional technology and the time according to the invention, it is concluded as follows.

$$\begin{matrix}( 3 \cdot T 0 + 1.5 \cdot ( n - 1 ) T 0 / 3 n \cdot T 0 = ( 3 + 1.5 \cdot ( n - 1 ) ) / 3 n \\ = ( 1.5 \cdot n + 1.5 ) / 3 n \\ = 1 / 2 + 1 / 2 n\end{matrix}$$

So, it approaches ½ the time required by the conventional technology as n increases. Actually, loading time, bonding time, unloading time, vacuuming time, handling of substrate time and the timing of loading or unloading substrates are not ideal, as assumed in the previous discussion. But the time to manufacture bonded substrates will be shortened, and according to this embodiment, the time can be shortened to somewhere close to half.

In the conventional substrate bonding method, if overlapping portion or sets like this embodiment are made, the unloading step as the third step of a k^{th} set of substrates and loading step as the first step of a k+1^{th} set of substrates can be proceeded at one time as the overlapping portion. In this case, the overall time using a conventional arrangement can be shortened by 0.5 T0. Therefore, making n pieces or sets of bonded substrates after a second set of substrates requires 2.5 T0 per each additional piece or set. So, the time to make n pieces or sets of substrates requires 3·T0+2.5·(n−1)·T0.

However, even in this case, as n increases, the time can be shortened using the present invention. Specifically, according to previous embodiment, it is possible to bond the substrates in about ⅗ of the time required using conventional techniques as follows.

$$\begin{matrix}\frac{( 3 \cdot T 0 + 1.5 \cdot ( n - 1 ) \cdot T 0}{( 3 \cdot T 0 + 2.5 \cdot ( n - 1 ) \cdot T 0 )} = \frac{( 3 + 1.5 \cdot ( n - 1 )}{( 3 + 2.5 \cdot ( n - 1 ) )} \\ = \frac{( 1.5 n + 1.5 )}{( 2.5 \cdot n + 0.5 )} \\ = \frac{( \frac{3}{5} \cdot n + \frac{3}{5} )}{( n + \frac{1}{5} )} \\ = \frac{( \frac{3}{5} + \frac{3}{5} \cdot n )}{( 1 + \frac{1}{5} \cdot n )}\end{matrix}$$

At this time, the first through third chambers C1, C2, C3 are in the medium vacuum state, allowing the substrates to be held in position through suction pickup. Specifically, it is arranged in the embodiment that a degree of vacuum for suction-pickup results from supply of a vacuum in a high vacuum state.

In accordance with the embodiment, the substrates are temporarily fixed to each other in the bonding chamber of the high vacuum state. The light source of UV light for temporary fixing may be provided for the third chamber C3, instead of the bonding chamber (second chamber C2), and the temporary fixing is performed in a medium-vacuum state in the third chamber C3.

As described in the foregoing, in accordance with the preferred embodiment of the present invention, the first and third chambers are variably controlled from the atmospheric pressure state to the medium vacuum state, while the second chamber is variably controlled from the medium vacuum state to the high vacuum state. This arrangement can shorten substantially the time taken to achieve the corresponding vacuum state in each of the three chambers. Further, supplying a nitrogen gas into each chamber eliminates an effect from moisture even when the vacuum state is varied. This eliminates the need for installing a turbo-molecular pump of a large capacity, contributing to an even more compact body of the apparatus.

The first embodiment of the present invention as described heretofore is the arrangement, in which the first chamber includes two robot hands as a transport mechanism for loading the upper and lower substrates, respectively, and the third chamber includes one robot hand as a transport mechanism for unloading the liquid crystal substrates that have undergone the bonding process.

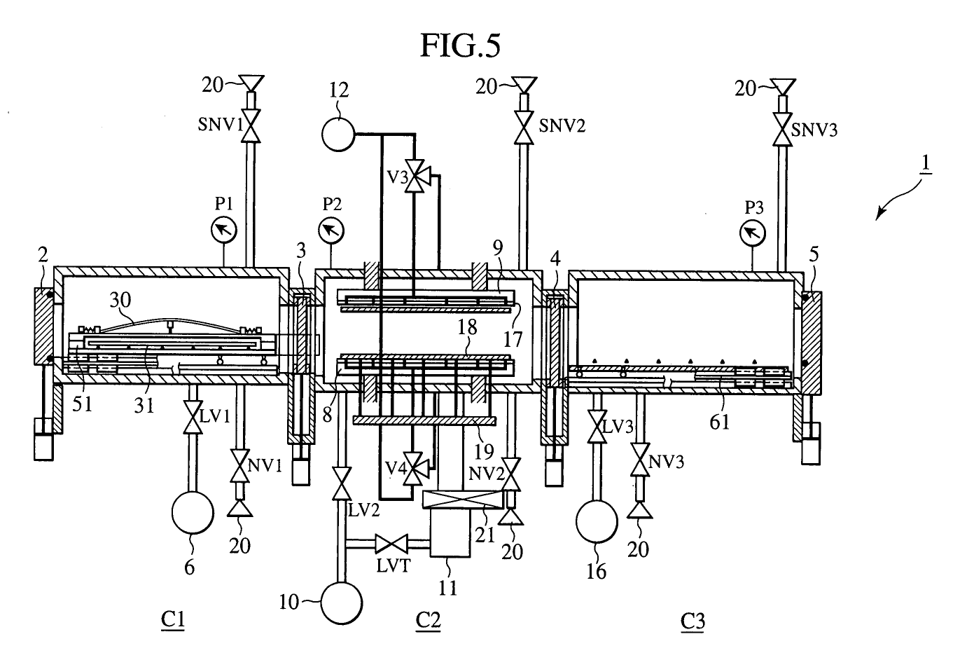

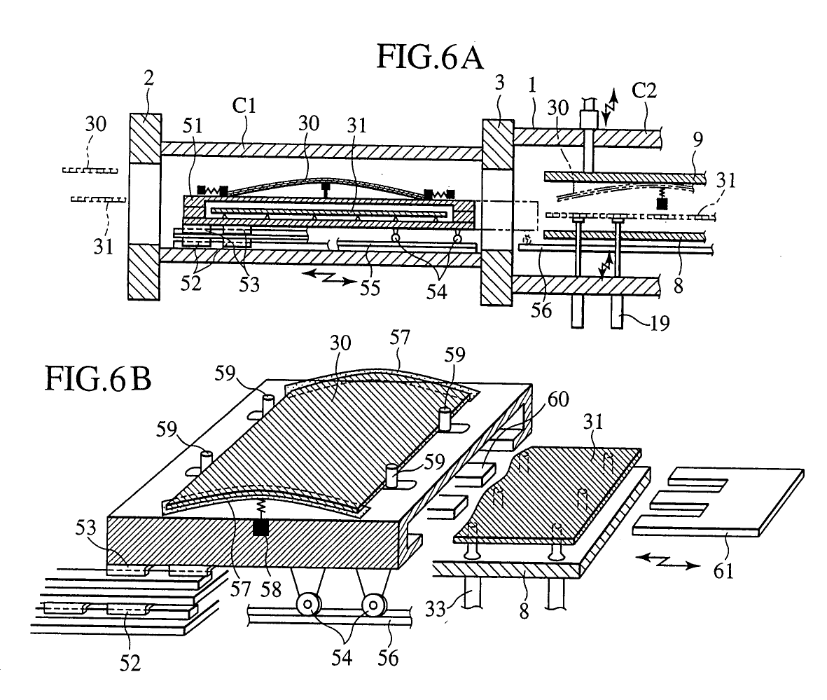

A second embodiment of the present invention incorporating a transport mechanism of a traveling dolly structure will be described with reference to FIGS. 5 and 6.

Like reference numerals refer to like elements between FIG. 5 and FIG. 1.

The second embodiment of the present invention depicted in FIG. 5 is widely different from the first embodiment of the present invention depicted in FIG. 1 in that a substrate loading dolly 51 is incorporated in the first chamber instead of the robot hands. The arrangement of the second embodiment of the present invention thereby eliminates the need for the suction pickup mechanism included in the robot hand. FIGS. 6A and 6B are views showing the loading dolly in detail.

FIG. 6A is a partial cross-sectional view of a first chamber and a second chamber. FIG. 6B is an enlarged view of the substrate loading dolly. The substrate loading dolly 51 is a two-tier structure transporting a lower substrate 31 on a lower tier and an upper substrate 30 on an upper tier (an upper surface of the dolly). Referring to FIGS. 6A and 6B, the lower tier includes a plurality of cantilever substrate supports 60. The upper tier includes an upper substrate curve holding mechanism so that the upper substrate can be transported while being curved in a transport direction. The upper substrate curve holding mechanism includes a plurality of substrate edge clamps 59 and a plurality of substrate support mechanisms 58. The plurality of substrate support mechanisms 58 is disposed near a center of the dolly, supporting the substrate by pushing the substrate upward. The substrate support mechanisms 58 are lined up in a row in a direction perpendicular to the transport direction. The upper substrate curve holding mechanism further includes curved substrate side supports 57 disposed on both sides on the upper tier in the direction perpendicular to the transport direction.

The substrate loading dolly 51 includes linear guide drive sections on both sides thereof. The drive sections travel along liner guides disposed in the first chamber. In the meantime, a plurality of tandem support rollers 54 disposed on the underside of the dolly allows the dolly to travel across guide rails 55 disposed in the first chamber C1 and guide rails 56 disposed in the second chamber C2. Specifically, the distance between wheels of the tandem support rollers 54 is longer than the distance between the guide rails 55 and guide rails 56. This is because the tandem support rollers 54 need to travel past a first gate valve with no rails placed thereon.

FIG. 6A shows an arrangement of a substrate lifter 19 included in the second chamber C2 with the lower table 8. Unlike the arrangement shown in FIG. 1, the substrate lifter 19 according to the second preferred embodiment of the present invention includes a plurality of pneumatic cylinders and a plurality of support pins that are moved up and down by the corresponding pneumatic cylinders.

The lower substrate 31 is loaded from the first chamber C1 to the second chamber C2 by the substrate loading dolly 51 as described above. The substrate lifter 19 disposed on the side of the lower table 8 lifts the lower substrate 31 off the lower tier. After the dolly is moved thereafter, the substrate lifter 19 is lowered so that the lower substrate 31 is placed horizontally on the surface of the lower table 8. The lower table 8 also includes an electrostatic pickup mechanism or a partial adhesion mechanism as a substrate holding mechanism. The substrate holding mechanism ensures that the lower substrate 31 is not moved on the surface of the lower table 8 during the processes of evacuation and substrate bonding.

The upper substrate 30, on the other hand, is loaded in the second chamber C2 with a central portion thereof in the transport direction being curved upwardly on the upper tier. As the upper table 9 is lowered down to the surface of the upper substrate 30, the central protruded portion of the upper substrate 30 first comes into contact with the upper table 9, being picked up through suction. The arrangement, in which the central portion of the upper substrate 30 is first picked up through suction, allows the upper substrate 30 to be held in position on the surface of the upper table 9 without being flexed, should the substrate be so large as to be easily flexed.

In operation, the first preferred embodiment of the present invention uses the upper and lower substrate loading robot hands for loading the upper and lower substrates, respectively, in the second chamber. In the second embodiment, on the other hand, the substrate loading dolly 51 includes the substrate supports 60 of the cantilever structure, on which the lower substrate 31 is mounted and the upper surface, on which the upper substrate 30 is transported in a curved position. In this respect, the second embodiment of the present invention differs from the first embodiment of the present invention in that the upper and lower substrates are loaded at the same time and transferred onto the upper and lower tables, respectively, at the same time. In other respects, the second embodiment of the present invention is similar to the first embodiment of the present invention and the description of the same aspects will be omitted.

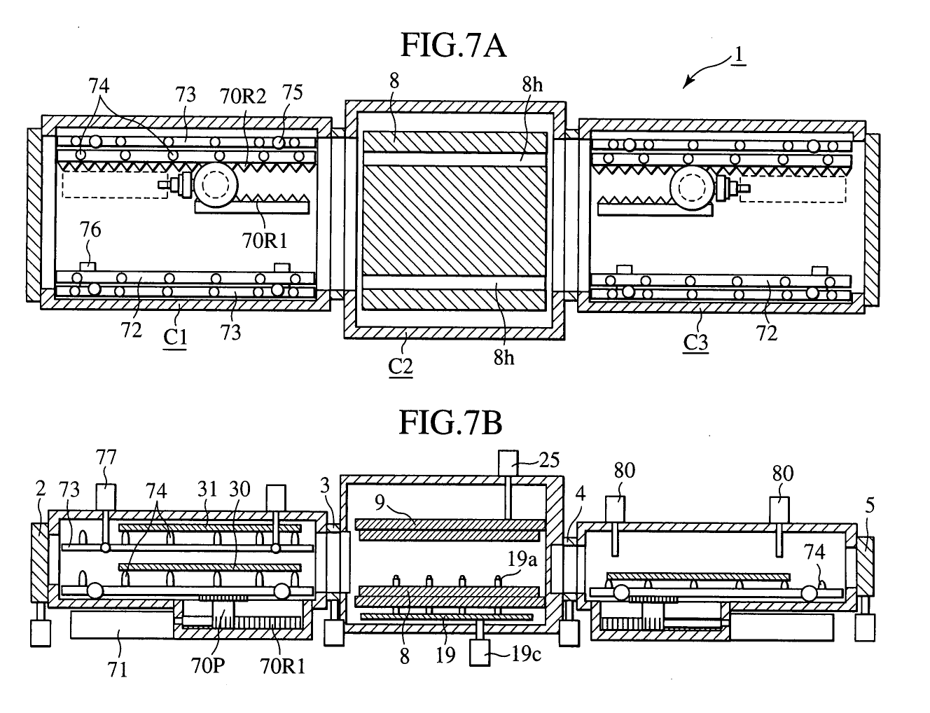

FIGS. 7A and 7B are views showing a third embodiment of the present invention.

A substrate loading mechanism according to the third embodiment of the present invention will be described with reference to FIGS. 7A and 7B. A cylinder 71 for driving a pinion shaft is disposed externally below a first chamber C1. A pinion 70P having gear teeth formed on an upper and lower sides thereof is rotatably mounted on a leading end of the cylinder shaft. Two guide plates 72 extending in the transport direction are disposed on both sides of the first chamber C1 so that substrates can be transported. Each of the guide plates 72 includes a plurality of support pins 74 that contact and support the substrate. The guide plate 72 on a first side includes a straight rack 70R2 for transmitting a drive force. It is arranged so that the gear teeth formed on the upper side of the aforementioned pinion 70P engages with the rack 70R2. Further, a rack 70R1 in meshing engagement with the gear teeth on the lower side of the pinion 70P is fixed to the chamber side. Although not shown in FIG. 7A or 7B, the guide plates 72 on the right and left sides are mutually coupled together. If the guide plate 72 on one side is driven, it drives the guide plate 72 on the other side, too. The pinion 70P is disposed on the side of the second chamber C2. The pinion 70P is formed such that if it moves the maximum distance, the substrate on the guide plate is located on the table surface in the second chamber C2.

The first chamber C1 also includes an elongated lift buffer 73 extending in the transport direction disposed on an upper portion in the first chamber C1. The lift buffer 73 temporarily holds the lower substrate 31. The lift buffer 73 includes a plurality of support pins 74 disposed on an upper portion thereof. The support pins support the lower substrate. The lift buffer 73 is disposed on the outside of the guide plate 72. Cylinders 77 for generating a drive force are secured at respective positions on the upstream and downstream sides in the transport direction. Although not shown, the cylinder 77 has a shaft coupled to the lift buffer 73 via an arm. The arm defines the position of the shaft of the cylinder 77 on the wall side of the first chamber C1. This is done to prevent the cylinder shaft from impeding the movement of the lower substrate 31 toward the second chamber C2. After the lower substrate 31 is transferred onto the support pins 74 on the guide plate 72, the lift buffer 73 is left standstill at the position to wait for a subsequent operation. Driving the cylinder 77 allows the lift buffers 73 to descend from a horizontal position of the upper portion of the support pins 74 of the guide plates 72.

To adopt such a structure, the lower substrate 31 is put upward inside the C1, and the upper substrate 30 is put downward inside the C1. Then, the upper substrate 30 is loaded to the second chamber C2 and is held by upper table 9, after which the lower substrate 31 is loaded to the second chamber C2 and is held by lower table 8. The lower substrate 31 is transferred onto the support pins 74 on the guide plate 72 before the lower substrate 31 becomes loaded to C2.

According to this operation, the upper table 9 has enough space to move up and down easily, because there is nothing around the lower table 8 when the upper substrate 30 is loaded to C2 and is held by the upper table 9, and also because, in this embodiment, bonding substrates is completed by moving the upper table 9 up and down.

On the other hand, if the upper substrate 30 is loaded to C2 after the lower substrate 31 is loaded to C2 and is held by the lower table 8, it will restrict the moving of the upper table 9. Moreover, the upper substrate 30 and/or the rack etc. may touch the lower substrate 31 incorrectly that has been applied by liquid crystal.

In this operation, bonding substrates is completed by moving the upper table 9 up and down. But, needless to say, it is permissible for the upper table 9 to be fixed and for the lower table 8 to move up and down in order to bond the substrates together. In such a case, however, it is preferable that the sequence of loading the substrates be such that the lower table 8 is loaded to C2 after the upper table 9 is loaded to C2 because of the same reason as previously discussed above.

In accordance with the third embodiment of the present invention, the lower table 8 disposed in the second chamber C2 is formed in its surface with guide plate grooves 8h adapted for ensuring smooth movement of the substrate loading and unloading guide plates 72. In addition, the arrangement according to the third embodiment includes a drive mechanism, disposed on the outside of the chamber, for moving the lower table in the X, Y, and θ directions so as to position the upper and lower substrates horizontally. A movable portion of the drive mechanism is disposed outside the chamber, and a connection provided therebetween comprises a bellows-like elastic member so as to prevent a vacuum from leaking.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A substrate bonding apparatus comprising:
a first chamber including respective loading mechanisms adapted to load an upper substrate and a lower substrate;
a vacuum pump adapted to change an inside of the first chamber from an atmospheric pressure state to a medium vacuum state between atmospheric pressure and a high vacuum state;
a second chamber adapted to receive the upper and lower substrates from the loading mechanisms in the medium vacuum state, to reduce the pressure to the high vacuum state, and to bond of the two substrates together; and
a third chamber including an unloading mechanism adapted to unload the bonded substrates from the second chamber in the medium vacuum state, wherein the bonded substrates are unloaded to the outside of the third chamber in an atmospheric state.

2. The apparatus according to claim 1, further comprising a vacuum pump provided for each of the first through third chambers to pick up substrates through suction in the medium vacuum state;
wherein a suction pickup system is connected to each of the first through third chambers, and a suction pickup force exerted by the suction pickup system is controlled by opening or closing a valve disposed midway between the suction pickup system and each of the first through third chambers.

3. The apparatus according to claim 1,
wherein a transport mechanism for transporting substrates from the first chamber to the second chamber includes a first transport robot for transporting the upper substrate and a second transport robot for transporting the lower substrate; and
wherein each of the first and second transport robots has a substrate transport arm including a plurality of suction pads for preventing the substrate from moving.

4. The apparatus according to claim 1,
wherein the transport mechanism includes a transport dolly for transporting two substrates mounted thereon; and
wherein the upper substrate is transported while being held in a protruded state.

5. The apparatus according to claim 1,
wherein the first chamber includes:
a holding mechanism for temporarily holding the lower substrate; and
a transport mechanism having a rack-and-pinion drive mechanism for transporting the upper and lower substrates, one by one, onto the second chamber.

6. The apparatus according to claim 1,
wherein an upper table of the second chamber includes a chuck using adhesion for holding the substrate in the high vacuum state.

7. The apparatus according to claim 1,
wherein the upper table of the second chamber includes a chuck using an electrostatic pickup force for holding the substrate in the high vacuum state.

8. The apparatus according to claim 1,
wherein the chamber is kept in the medium vacuum state during transport of the upper and lower substrates in order to prevent the upper and lower substrates that have been bonded together from being positionally deviated from each other.

9. The apparatus according to claim 1, further comprising:
a mechanism for supplying, at all times, the chamber with a gaseous body to be exhausted through suction pickup which is employed for holding the substrates in the medium vacuum state.

10. The apparatus according to claim 1, further comprising:
measuring means provided for each of the first through third chambers for measuring pressure in each of the chambers; and
control means for controlling a degree of vacuum in each of the chambers.

11. A substrate bonding apparatus comprising:
a bonding chamber in a high vacuum state, adapted to accomplish bonding of an upper and a lower substrate together;
a loading chamber adapted to receive the upper and lower substrates and to unload, in a medium vacuum state between the high vacuum state and an atmospheric pressure state, the upper and lower substrates onto the bonding chamber; and
a unloading chamber adapted to receive the bonded substrates in the medium vacuum state between the high vacuum state and the atmospheric pressure state from the bonding chamber.

12. A substrate bonding apparatus comprising:
a first chamber adapted to load upper and lower substrates;
a second chamber adapted to bond together the upper and lower substrates received from the first chamber as a bonded substrate; and
a third chamber adapted to unload the bonded substrate;
wherein the first chamber and the third chamber are kept between an atmospheric pressure state and a medium vacuum state and the second chamber is kept between the medium vacuum state and a high vacuum state.

13. A method for bonding substrates together, the method comprising the steps of:
loading an upper and a lower substrate in a medium vacuum state having a pressure between a high vacuum pressure and an atmospheric pressure into a bonding chamber;
bringing the bonding chamber into a high vacuum state;
bonding the upper and lower substrates together; and
unloading the bonded substrates in the medium vacuum state from the bonding chamber.

14. A method according to claim 13, wherein the steps are repeated in succession on successive sets of upper and lower substrates so that, after one set of bonded substrates is removed from the bonding chamber, a new set of upper and lower substrates to be bonded is loaded into the bonding chamber.

15. A substrate bonding method for bonding an upper substrate and a lower substrate, the lower substrate including an area inside an annularly applied sealant, onto which liquid crystal is dropped, the method comprising the steps of:
bringing a loading chamber for loading the upper and lower substrates from an atmospheric pressure state to a medium vacuum state,
loading the upper and lower substrates into a bonding chamber set in the medium vacuum state;
bringing the bonding chamber into a high vacuum state and bonding together the upper and lower substrates; and
unloading the bonded substrates to a post-process chamber in the medium vacuum state.

16. A substrate bonding method according to claim 15, wherein the steps are repeated in succession on successive sets of upper and lower substrates so that, after one set of bonded substrates is removed from the bonding chamber, a new set of upper and lower substrates to be bonded is loaded into the bonding chamber.

17. The substrate bonding method according to claim 16,
wherein, while bonding of the upper and lower substrates is being carried out in the bonding chamber brought into the high vacuum state, the loading chamber is brought into the atmospheric state and loading of upper and lower substrates to be bonded together next is carried out.

18. The substrate bonding method according to claim 15,
wherein the bonded substrates loaded into the post-process chamber in the medium vacuum state are temporarily fixed together by letting part of the sealant be irradiated with light.

19. A substrate loading dolly comprising:
a substrate placement pedestal including an upper table and a lower table for holding respective substrates, and loading the upper and lower substrates into a bonding chamber in which either the upper table or the lower table is horizontally moved to position the upper and lower substrates and either the upper table or the lower table is vertically moved to reduce a gap therebetween to permit bonding of the two substrates together;
wherein the substrate placement pedestal includes an upper substrate curve holding mechanism adapted to hold the upper substrate with a central portion thereof curved protrudingly in a transport direction.

20. A substrate loading dolly according to claim 19,
wherein the substrate loading dolly has a substrate support mechanism adapted to be lined up in a row in a direction perpendicular to the transport direction and to support the upper substrate by pushing the substrate upward.

21. A substrate loading dolly according to claim 19,
wherein the substrate loading dolly has a plurality of substrate edge clamps adapted to be lined up in a row in a direction perpendicular to the transport direction and to clamp the edge of the upper substrate.

22. A substrate loading dolly according to claim 19,
wherein the substrate loading dolly has curved substrate side supports disposed on both sides on an upper tier corresponding to the upper substrate in a direction perpendicular to the transport direction.

23. A substrate loading dolly according to claim 19,
wherein the lower substrate is held inside the substrate loading dolly.

24. A substrate loading dolly according to claim 23,
wherein the substrate loading dolly has a plurality of cantilever substrate supports on which the lower substrate is mounted.

25. A substrate loading dolly according to claim 23,
wherein the upper and lower substrate are loaded to a bonding chamber simultaneously.

26. A product made by the process of claim 13.

27. A product made by the process of claim 15.

28. An apparatus according to claim 1, wherein the medium vacuum state is 100 ˜1,000[Pa].

29. An apparatus according to claim 1, wherein the medium vacuum state is 100 ˜150[Pa].

30. An apparatus according to claim 1, wherein the high vacuum state is less than 5[Pa].

31. An apparatus according to claim 1, wherein the high vacuum state is less than 1[Pa].

32. An apparatus according to claim 1, wherein the high vacuum state is less than 0.67[Pa].

33. A method according to claim 15, wherein the medium vacuum state is 100 ˜1,000[Pa].

34. A method according to claim 15, wherein the medium vacuum state is 100 ˜150[Pa].

35. A method according to claim 15, wherein the high vacuum state is less than 5[Pa].

36. A method according to claim 15, wherein the high vacuum state is less than 1[Pa].

37. A method according to claim 15, wherein the high vacuum state is less than 0.67[Pa].

38. A substrate bonding apparatus comprising means for bonding a plurality of sets of substrates in succession in a vacuum, said means including:
a first chamber including respective loading means for loading successive sets of upper and lower substrates to be bonded;
a vacuum means for changing an inside of the first chamber from an atmospheric pressure state to a medium vacuum state between atmospheric pressure and a high vacuum state each time a new set of substrates is loaded into the first chamber;
a second chamber including means for receiving the sets of upper and lower substrates from the loading mechanisms in the medium vacuum state, to reduce the pressure to the high vacuum state, and to bond of the two substrates together each time a new set of substrates is received by the second chamber; and
a third chamber including an unloading means for unloading the sets of bonded substrates from the second chamber in the medium vacuum state, wherein the bonded substrates are unloaded to the outside of the third chamber in an atmospheric state.
